(19) United States
(12) Patent Application Publication
(10) Pub. No.: US 2024/0222648 A1
(43) Pub. Date: Jul. 4, 2024

(54) HIGHLY ACTIVE AND ANTI-CARBON-DEPOSITION LIQUID FUEL SOLID OXIDE FUEL CELL ANODE WITH SELF-HYDRATION ABILITY, PREPARATION AND USE THEREOF

(71) Applicant: South China University of Technology, Guangzhou (CN)

(72) Inventors: Yu CHEN, Guangzhou (CN); Kang XU, Guangzhou (CN)

(73) Assignee: South China University of Technology, Guangzhou (CN)

(21) Appl. No.: 18/360,249

(22) Filed: Jul. 27, 2023

(30) Foreign Application Priority Data
Dec. 30, 2022 (CN) 202211724548.1

(51) Int. Cl. H01M 4/90; H01M 4/88; H01M 8/1009; H01M 8/1253

(52) U.S. Cl. CPC H01M 4/9033; H01M 4/8842; H01M 8/1009; H01M 8/1253; H01M 2008/1293; H01M 2300/0077

(57) ABSTRACT

The present disclosure belongs to the technical field of solid oxide fuel cell, and discloses a highly active and anti-carbon-deposition liquid fuel solid oxide fuel cell anode with self-hydration ability, a preparation and use thereof. The highly active and anti-carbon-deposition liquid fuel solid oxide fuel cell anode with self-hydration ability of the present disclosure, comprises: a NiO-YSZ anode, and an oxide skeleton Ru/Ce_{0.95}Ru_{0.05-x}O_{2-δ} loaded on the NiO-YSZ anode, wherein the oxide skeleton Ru/Ce_{0.95}Ru_{0.05-x}O_{2-δ} is covered with Ru nanoparticles, and δ indicates a content of oxygen vacancy. In the anode of the solid oxide fuel cell of the present disclosure, a large amount of Ce_{0.95}Ru_{0.05}O_{2-δ} nanoparticles are successfully adheres on the surface of NiO-YSZ grains, so that both the catalytic decomposition activity of liquid hydrocarbon fuel of the anode and the durability of the anode in hydrocarbon fuel environments have been significantly improved.

### CROSS-REFERENCE TO RELATED APPLICATION

The present disclosure is based on and claims the priority of the Chinese Patent Application No. 2022117245481, filed on Dec. 30, 2022, the entire contents of which are incorporated herein by reference.

### TECHNICAL FIELD

The present disclosure belongs to the technical field of solid oxide fuel cell, in particular relates to a highly active and anti-carbon-deposition liquid fuel solid oxide fuel cell anode with self-hydration ability, preparation and use thereof.

### BACKGROUND

Due to its high efficiency and unique fuel flexibility, solid oxide fuel cells (SOFCs) have shown the potential to become one of the most promising energy conversion device. Although hydrogen is the most commonly used fuel in SOFCs, its widespread utilization is hindered by problems of high production costs and difficulties in storage and transportation, etc. Liquid fuels (such as methanol, ethanol, ethylene glycol, and isopropanol) are ideal fuels for SOFCs due to their relatively simple structure compared to other gaseous hydrocarbons and higher volumetric energy density than hydrogen. However, the direct utilization of liquid fuels in SOFCs still remains a huge challenge, as the surface of the most advanced nickel (Ni) based cermet anode is prone to coking. Carbon deposition may block the active sites of the reaction and thus significantly reduce the performance. In order to directly utilize liquid fuels without additional reformers, significant efforts have been made to improve the anti-carbon-deposition ability of the anodes of solid oxide fuel cells. For example, depositing a thin protective layer on the surface of nickel is considered as an effective method to alleviate the problem of carbon deposition. Although some progress has been made, new alternative anodes are still unsatisfactory due to problems such as high cost and insufficient catalytic activity, etc. In addition, dry (or steam) reforming by mixing methanol with carbon dioxide (or water) can effectively inhibit carbon deposition. Adding H₂O to methanol at an appropriate steam/carbon (S/C) ratio can effectively inhibit the generation of carbon deposition by promoting the reaction between H₂O and C to form CO/CO₂ and H₂. Although this method effectively inhibits carbon deposition and improves cell durability, it requires complex water management and heating systems, thereby greatly increasing the complexity and cost of the system.

### SUMMARY

In order to overcome the above-mentioned shortcomings and deficiencies of the prior art the primary purpose of the present disclosure is to provide a highly active and anti-carbon-deposition liquid fuel solid oxide fuel cell anode with self-hydration ability.

Another purpose of the present disclosure is to provide a preparation method of the above-mentioned highly active and anti-carbon-deposition liquid fuel solid oxide fuel cell anode with self-hydration ability.

Yet another purpose of the present disclosure is to provide use of the above-mentioned highly active and anti-carbon-deposition liquid fuel solid oxide fuel cell anode with self-hydration ability in the solid oxide fuel cell.

The purposes of the present disclosure are achieved through the following solution.

A highly active and anti-carbon-deposition liquid fuel solid oxide fuel cell anode with self-hydration ability, comprising: a NiO-YSZ anode; and an oxide skeleton Ru/Ce_{0.95}Ru_{0.05-x}O_{2-δ} loaded on the NiO-YSZ anode, wherein the oxide skeleton Ru/Ce_{0.9}5Ru_{0.05-x}O_{2-δ} is covered with Ru nanoparticles, and S indicates a content of oxygen vacancy.

The NiO-YSZ anode has a finger-like through-hole structure, mainly consists of NiO and YSZ; and YSZ is 8 mol % Y₂O₃-stabilized ZrO₂.

A preparation method of the highly active and anti-carbon-deposition liquid fuel solid oxide fuel cell anode with self-hydration ability comprises the following steps:
(1) preparing a catalyst solution containing cerium and ruthenium; and
(2) infiltrating the catalyst solution on a surface of a NiO-YSZ anode, then oven-drying, calcining, and reducing to obtain a highly active and anti-carbon-deposition liquid fuel solid oxide fuel cell anode with self-hydration ability.

The catalyst solution containing cerium and ruthenium described in step (1) is an aqueous solution comprising cerium nitrate and ruthenium nitrosyl nitrate, wherein cerium nitrate is cerium nitrate containing crystal water or cerium nitrate free of crystal water, and a content of Ru in the ruthenium nitrosyl nitrate is 1.5% w/v in g/mL.

A molar ratio of cerium to ruthenium in step (1) is 19:1.

A total concentration of cerium and ruthenium in the catalyst solution described in step (1) is 0.05-0.2 mol/L.

The infiltration process described in step (2) is carried out on a circular anode with a diameter of 14-16 millimeters; the amount of catalyst solution infiltrated at one time is 5-15 μL, and the total amount of catalyst solution infiltrated is 100-200 μL.

The oven-drying described in step (2) is conducted at a temperature of 65-75° C., and the oven-drying lasts for 20-40 min, preferably 30 min.

The infiltration and oven-drying are repeated before conducting the calcination described in step (2) until a loading amount of the catalyst is 1.67-3.35 mg/cm², preferably 2.51 mg/cm².

The calcination described in step (2) is conducted at an atmosphere of ambient air; the calcination described in step (2) is conducted at a temperature of 700-800° C., preferably 800° C., and lasts for 1-2 hours.

The reduction described in step (2) comprises introducing a reducing gas or a mixed gas comprising a reducing gas and an inert gas for reduction, preferably hydrogen; a flow rate of the reducing gas or the mixed gas is 20-50 mL/min, preferably 30 mL/min; the reduction is conducted at a temperature of 700-800° C., preferably 800° C.; the reduction lasts for 1-2 hours, preferably 1 hour.

A preparation method of the NiO-YSZ anode described in step (2) includes the following steps:
S1: ball-milling NiO, YSZ, a water-soluble polymer compound, a thermoplastic polymer material, and an organic solvent to obtain a NiO-YSZ anode slurry; and ball-milling graphite, an organic solvent, a thermoplastic polymer material, and a water-soluble polymer compound to obtain a graphite slurry;
S2: casting the graphite slurry onto a substrate to obtain a graphite layer; casting the NiO-YSZ anode slurry onto the graphite layer to obtain a graphite/anode layer; and soaking the graphite/anode layer in water to complete the phase conversion process;
S3: taking out the graphite/anode layer that has completed the phase conversion process, drying in air, calcining during which the graphite layer is burned off at high temperature and removed from a surface of the graphite/anode layer, to obtain a Ni-YSZ anode with a finger-like through-hole structure.

The water-soluble polymer compound described in step S1 is polyvinylpyrrolidone, the thermoplastic polymer material is polyethersulfone, and the organic solvent is 1-methyl-2-vinylpyrrolidone.

In the anode slurry described in step S1, a mass ratio of the water-soluble polymer compound, the thermoplastic polymer material, and the organic solvent is (0.1-0.3):1:(5-7); a mass ratio of NiO to the water-soluble polymer compound is (30-50):(0.5-1.5); and a mass ratio of NiO to YSZ is (5.5-6.5):(3.5-4.5).

In the graphite slurry described in step S1, a mass ratio of graphite, the water-soluble polymer compound, the thermoplastic polymer material, and the organic solvent is (10-30):(1-1.5):(4-6):(20-40).

Both of the ball-millings described in step S1 all last for 70-80 hours.

A thickness of the graphite layer described in step S2 is 0.2-0.3 millimeters; a thickness of the graphite/anode layer is 0.6-0.7 millimeters; and the soaking lasts for 8-12 hours.

The calcination described in step S3 is conducted at 900-1100° C. in a muffle furnace for 1.5-2.5 hours; preferably, the graphite/anode layer is prepared into a desired shape such as a thin flake before calcination.

A highly active and anti-carbon-deposition liquid fuel solid oxide fuel cell with self-hydration ability, comprising the above-mentioned highly active and anti-carbon-deposition liquid fuel solid oxide fuel cell anode with self-hydration ability, a functional layer, an electrolyte layer, a barrier layer and a cathode which are stacked successively, and whose structure is Ru/Ce_{0.95}Ru_{0.05}O_{2-δ}/NiO-YSZ|YSZ|GDC|PBCFN.

The anode is a NiO-YSZ anode which is loaded with the oxide skeleton Ru/Ce_{0.95}Ru_{0.05-x}O_{2-δ} covered with Ru nanoparticles.

The functional layer is composed of NiO and YSZ, with a mass ratio of NiO to YSZ of (0.8-1):(0.8-1), preferably 1:1.

The electrolyte layer is YSZ.

The barrier layer is a GDC barrier layer, wherein GDC is 10 mol % Gd₂O₃— doped CeO₂.

The cathode is a double perovskite oxide PrBaCo_{1.6}Fe_{0.2}Nb_{0.2}O_{5+δ} (PBCFN).

A preparation method of the highly active and anti-carbon-deposition liquid fuel solid oxide fuel cell with self-hydration ability comprises the following steps:
preparing a NiO-YSZ anode supported half cell by phase conversion and a co-sintering method, comprising a NiO-YSZ anode support layer and a NiO-YSZ functional layer, a YSZ electrolyte layer, and a GDC barrier layer;
screen-printing a PBCFN cathode slurry on a surface of the electrolyte of the half cell by a screen printing method, and then calcining the same to obtain the desired NiO-YSZ|YSZ|GDC|PBCFN single cell; and
infiltrating a Ce_{0.95}Ru_{0.05}O_{2-δ} catalyst onto an uncovered side of the NiO-YSZ anode by infiltration method to obtain a single cell Ce_{0.95}Ru_{0.05}O_{2-δ}/NiO-YSZ|YSZ|GDC|PBCFN, and then performing reduction on the single cell Ce_{0.95}Ru_{0.05}O_{2-δ}/NiO-YSZ|YSZ|GDC|PBCFN to transform into a highly active and anti-carbon-deposition liquid fuel solid oxide fuel cell with self-hydration ability Ru/Ce_{0.95}Ru_{0.05-x}O_{2-δ}/Ni-YSZ|YSZ|GDC|PBCFN.

The NiO-YSZ anode supported layer is a NiO-YSZ anode without loading the Ce_{0.95}Ru_{0.05}O_{2-δ} catalyst.

An active area of the PBCFN cathode slurry obtained by screen printing is 0.2826 cm².

The preparation method of the highly active and anti-carbon-deposition liquid fuel solid oxide fuel cell with self-hydration ability specifically comprises the following steps:
1) preparing a NiO-YSZ anode with a finger-like through-hole structure;
2) infiltrating a NiO-YSZ functional layer slurry and a YSZ electrolyte layer slurry onto the NiO-YSZ anode with the finger-like through-hole structure successively, and then performing co-sintering;
3) coating a GDC barrier layer slurry onto a electrolyte layer, then sintering to obtain a GDC barrier layer to block a reaction between the electrolyte (YSZ) and a cathode (PBCFN);
4) preparing a cathode on the barrier layer, to obtain a solid oxide fuel cell, wherein a double perovskite oxide PrBaCo_{1.6}Fe_{0.2}Nb_{0.2}O_{5+δ} is used as a cathode of the solid oxide fuel cell, and δ indicates a content of oxygen vacancy; and
5) infiltrating a catalyst solution onto an uncovered side of the NiO-YSZ anode with the finger-like through-hole structure of the solid oxide fuel cell, then oven-drying, calcining, and reducing to obtain a highly active and anti-carbon-deposition liquid fuel solid oxide fuel cell with self-hydration ability.

The NiO-YSZ functional layer slurry described in step 2) is obtained by ball-milling NiO, YSZ, a dispersant polyvinyl butyral (PVB), and ethanol; and a mass ratio of NiO, YSZ, the dispersant, and ethanol is 0.5:0.5:(0.4-0.6):(5-15).

The YSZ electrolyte layer slurry described in step 2) is obtained by ball-milling YSZ, a dispersant polyvinyl butyral (PVB), and ethanol; and a mass ratio of YSZ, the dispersant, and ethanol is 1:(0.1-1):(8-15).

Both of the ball-millings described in step 2) last for 12-48 hours, preferably 24 hours.

The co-sintering described in step 2) is conducted in a muffle furnace at a sintering temperature of 1350-1450° C. for 2-5 hours.

The GDC barrier layer slurry described in step 3) is obtained by ball-milling GDC, ethyl cellulose, terpineol, and acetone; and a mass ratio of GDC, ethyl cellulose, terpineol, and acetone is (0.5-1):(0.1-0.2):(1.8-2.0): 10.

The ball milling time described in step 3) lasts for 12-48 hours, preferably 24 hours.

The sintering described in step 3) is conducted in a muffle furnace at a sintering temperature of 1250-1350° C. for 2-5 hours.

The cathode in step 4) is obtained by a method comprising the following steps:
P1: dissolving and evenly mixing reagents containing Pr, Ba, Co, Fe, and Nb in water; adding glycine and citric acid, and volatilizing the water under heating and stirring to obtain a gel-like material; oven-drying the gel-like material to obtain a PBCFN cathode material precursor; and then calcining the precursor to obtain a PBCFN cathode material powder; and
P2: grinding the obtained PBCFN cathode material powder, ethyl cellulose, and terpineol into slurry; screen-printing the slurry on a surface of GDC, and then calcining at high temperature to obtain the cathode.

A molar ratio of Pr, Ba, Co, Fe, and Nb described in step P1 is 1:1:1.6:0.2:0.2.

The reagents containing Pr, Ba, Co, Fe, and Nb described in step P1 are Pr(NO₃)₃·6H₂O, Ba(NO₃)₂, Co(NO₃)₂·6H₂O, Fe(NO₃)₃·9H₂O, and C₄H₄NNbO₉·nH₂O, respectively.

A molar ratio of metal ions (including Pr, Ba, Co, Fe, and Nb), glycine, and citric acid described in step P1 is 1:(0.5-1):(0.5-1).

A temperature of the heating and stirring described in step P1 is 80-100° C., preferably 85° C.; the oven-drying is conducted at a temperature of 250-300° C., preferably 300° C., and the oven-drying lasts for 1-5 hours, preferably 2 hours; the calcination is carried out in a muffle furnace at a calcination temperature of 800-1000° C., preferably 900° C., for 1-5 hours, preferably 2 hours.

A mass ratio of PBCFN cathode material powder, ethyl cellulose and terpineol described in step P2 is 1:(0.02-0.06):(0.74-0.78); and the calcination is carried out in a muffle furnace at 900-1100° C. for 1.5-2.5 hours.

The current collection method of the highly active and anti-carbon-deposition liquid fuel solid oxide fuel cell with self-hydration ability is to connect the electrode surface with the silver wire by using silver paste (DAD-87, purchased from Shanghai Research Institute of Synthetic Resin) for current collection.

The highly active and anti-carbon-deposition liquid fuel solid oxide fuel cell with self-hydration ability refers to the oxygen ion conducting solid oxide fuel cell which uses liquid hydrocarbons as fuels.

The mechanism of the present disclosure is as follows.

During the actual operation of fuel cells, the reaction of 2H⁺+O²⁻→H₂O (1) will occur in the anode. When experimenting with the liquid hydrocarbon fuels, it is found that the carbon deposits generated in the anode can be removed by H₂O via the reaction of C+H₂O→CO+H₂ (2). Catalysts with hydration ability can store the water generated by the reaction (1) occurred in the anode and release it during the decarbonization, thereby promoting the progress of reaction (2) to generate appropriate steam/carbon ratio, effectively reforming hydrocarbon fuels, so that the goal of removing carbon deposition is achieved, and the sustainable operation of SOFC is realized. Therefore, the design of a catalyst with self-hydration ability to promote the removal of carbon deposition under actual operating conditions according to the present disclosure is a theoretically feasible method. It is reported that Ru catalysts exhibit high catalytic activity by breaking C—H bonds and forming less coke. As inspired by the fact that the desolventized nanoparticles in the parent phase have high activity and excellent durability, it is assumed that Ru nanoparticles (NPs) can also be desolventized from CeO₂ under operating conditions, which may facilitate to break the C—H bond and inhibit carbon deposition.

The present disclosure proposes a highly active and coking resistant catalyst with a nominal composition of Ce_{0.95}Ru_{0.05}O_{2-δ} (CR₅O). Under actual operating conditions, it is recombined into an oxide skeleton Ru/Ce_{0.95}Ru_{0.05-x}O_{2-δ} (Ru/CR₅₋ₓO) covered with Ru nanoparticles through hydrogen reduction. The catalyst formed in situ is represented as Ru/CR₅₋ₓO. Experiments have shown that the Ru/CR₅₋ₓO catalyst exhibits ideal self-hydration ability, which promotes the reforming of hydrocarbon fuels.

The present disclosure has the following advantages and beneficial effects as compared to prior art.
1. The present disclosure relates to a solid oxide fuel cell anode, which is prepared by successfully adhering a large amount of Ce_{0.95}Ru_{0.05}O_{2-δ} nanoparticles on the surface of NiO-YSZ grains of the anode by using infiltration method. Both the catalytic decomposition activity of liquid hydrocarbon fuel of the anode and the durability of the anode in hydrocarbon fuel environments have been significantly improved. When methanol is used as fuel, the single cell comprising such an anode structure achieves ultra-high power densities of 0.604 W/cm², 1.010 W/cm², and 1.370 W/cm² at 700° C., 750° C., and 800° C., respectively. In addition, when liquid methanol is directly used as fuel, the cell operates stably at 750° C. for about 200 hours without obvious carbon deposition.
2. The preparation method of the present disclosure has the characteristics of simple process, low cost, and easy operation, etc. The present disclosure provides theoretical and practical guidance for the development of commercial solid oxide fuel cell anode structure and materials.

### BRIEF DESCRIPTION OF DRAWINGS

FIG. 1A is the HAADF STEM image of Ru/Ce_{0.95}Ru_{0.05-x}O_{2-δ} catalyst nanoparticles of the present disclosure; FIG. 1B shows the corresponding Fast Fourier Transform (FFT) modes of the left box in FIG. 1A, and FIG. 1C shows the corresponding Fast Fourier Transform (FFT) modes of the right box in FIG. 1A.

FIG. 2 shows the diffraction of x-rays (XRD) patterns of Ce_{0.95}Ru_{0.05}O_{2-δ} powder and Ru/Ce_{0.95}Ru_{0.05-x}O_{2-δ} powder described in the present disclosure.

FIG. 3a shows the X-ray photoelectron spectroscopy (XPS) pattern and corresponding fitted lines of Ru3p_{3/2} orbitals of Ru/Ce_{0.95}Ru_{0.05-x}O_{2-δ} powder described in the present disclosure; and FIG. 3b shows the XPS pattern and corresponding fitted lines of Ce 3d of Ru/Ce_{0.95}Ru_{0.05-x}O_{2-δ} powder described in the present disclosure.

FIG. 4 shows the FTIR patterns of the as-prepared CeO₂, Ce_{0.95}Ru_{0.05}O_{2-δ}, the reduced CeO₂ and Ru/Ce_{0.95}Ru_{0.05-x}O_{2-δ} powder, after the steam treatment.

FIG. 5a shows a cross-sectional SEM image of the cell according to the present disclosure; FIG. 5b shows a detailed SEM image of the cell according to the present disclosure; and FIG. 5c shows a detailed SEM image of the Ru/Ce_{0.95}Ru_{0.05-x}O_{2-δ} catalyst coated anode; wherein ASL is the anode support layer, and AFL is the anode functional layer.

FIG. 6a shows the I-V-P curve of the single cell (Ru/Ce_{0.95}Ru_{0.05}.XO_{2-δ}/NiO-YSZ|YSZ|GDC|PBCFN) as measured at 750° C. using hydrogen, methanol, ethanol, ethylene glycol, isopropanol, and methane as fuels, respectively, wherein the single cell comprises the Ru/Ce_{0.95}Ru_{0.05-x}O_{2-δ} nanoparticles (2.51 mg/cm² Ce_{0.95}Ru_{0.05}O_{2-δ}) coated NiO-YSZ as anode, according to the present disclosure; and FIG. 6b shows the polarization resistance (Rₚs) of the single cell (Ru/Ce_{0.95}Ru_{0.05-x}O_{2-δ}/NiO-YSZ|YSZ|GDC|PBCFN) as measured at 750° C. using hydrogen, methanol, ethanol, ethylene glycol, isopropanol, and methane as fuels, respectively, wherein the single cell comprises the Ru/Ce_{0.95}Ru_{0.05-x}O_{2-δ} nanoparticles (2.51 mg/cm² Ce_{0.95}Ru_{0.05}O_{2-δ}) coated NiO-YSZ as anode, according to the present disclosure.

FIG. 7a shows the I-V-P curve of the single cell (Ru/Ce_{0.95}Ru_{0.05-x}O_{2-δ}/Ni-YSZ|YSZ|GDC|PBCFN) as measured at 700-800° C. using hydrogen as fuel gas and ambient air as oxidant, wherein the single cell comprises the nanoparticles (2.51 mg/cm² Ce_{0.95}Ru_{0.05}O_{2-δ}) coated NiO-YSZ as anode, according to the present disclosure; and FIG. 7b shows the area specific impedance diagram of the single cell (Ru/Ce_{0.95}Ru_{0.05-x}O_{2-δ}/Ni-YSZ|YSZ|GDC|PBCFN) as measured at 700-800° C. using hydrogen as fuel gas and ambient air as oxidant, wherein the single cell comprises the nanoparticles (2.51 mg/cm² Ce_{0.95}Ru_{0.05}O_{2-δ}) coated NiO-YSZ as anode, according to the present disclosure.

FIG. 8a shows the I-V-P curve of the single cell (Ru/Ce_{0.95}Ru_{0.05X}O_{2-δ}/Ni-YSZ|YSZ|GDC|PBCFN) as measured at 700-800° C. using methanol as fuel gas and ambient air as oxidant, wherein the single cell comprises the nanoparticles (2.51 mg/cm² Ce_{0.95}Ru_{0.05}O_{2-δ}) coated NiO-YSZ as anode, according to the present disclosure; and FIG. 8b shows the area specific impedance diagram of the single cell (Ru/Ce_{0.95}Ru_{0.05-x}O_{2-δ}/Ni-YSZ|YSZ|GDC|PBCFN) as measured at 700-800° C. using methanol as fuel gas and ambient air as oxidant, wherein the single cell comprises the nanoparticles (2.51 mg/cm² Ce_{0.95}Ru_{0.05}O_{2-δ}) coated NiO-YSZ as anode, according to the present disclosure.

FIG. 9a shows the durability of operation of a single cell comprising a blank anode, wherein the single cell is operated at 0.7V and 750° C., with H₂ as fuel firstly and then CH₃OH, according to the present disclosure; and FIG. 9b shows the durability of operation of a single cell comprising a Ru/Ce_{0.95}Ru_{0.05-x}O_{2-δ}-coated anode, wherein the single cell is operated at 0.7V and 750° C., with CH₃OH as fuel, according to the present disclosure.

FIG. 10 shows the Raman spectrum of the blank Ni-YSZ dense sheet and Ru/Ce_{0.95}Ru_{0.05-x}O_{2-δ}-coated Ni-YSZ dense sheet after exposure to CH₃OH for 1 hour at 750° C.

### DETAILED DESCRIPTION

The present disclosure will be further described in detail below in conjunction with examples and accompanying drawings, however, the implementations of the present disclosure are not limited thereto. The conventional conditions or conditions recommended by the manufacturers shall be followed unless specific conditions are specified in the examples. The reagents or instruments used of which the manufacturers are not indicated are conventional products that are commercially available.

The reagents used in the examples are commercially available unless special instructions are indicated.

Preparation of Ce_{0.95}Ru_{0.05}O_{2-δ} Catalyst Material Powder:

The reagents containing Ce and Ru were dissolved and evenly mixed in water; glycine and citric acid were added, and the water was volatilized under heating and stirring to obtain a gel-like material; the gel-like material was then oven-dried to obtain a Ce_{0.95}Ru_{0.05}O_{2-δ} material precursor; and the material precursor was then calcined in a muffle furnace to obtain the Ce_{0.95}Ru_{0.05}O_{2-δ} catalyst material powder.

Wherein, the molar ratio of Ce to Ru was 0.95:0.05;
the reagents containing Ce and Ru were Ce(NO₃)₃·6H₂O and Ru(NO)(NO₃)ₓ(OH)_{y} where x+y=3, respectively;
the molar ratio of metal ions (Ce and Ru):glycine:citric acid was 1:0.75:0.75; and
the temperature for heating and stirring was 85° C.; the oven-drying temperature was 300° C. and the oven-drying time was 2 hours; the calcination temperature was 900° C. and the calcination time was 2 hours.
   Preparation of Ru/Ce_{0.95}Ru_{0.05-x}O_{2-δ} Catalyst Material Powder:

The Ce_{0.95}Ru_{0.05}O_{2-δ} material powder was reduced at 800° C. for 2 hours in a 4% H₂—Ar mixed gas to obtain the Ru/Ce_{0.95}Ru_{0.05-x}O_{2-δ} catalyst material powder.

### Example 1

This example provided a preparation method of a solid oxide fuel cell cathode material PrBaCo_{1.6}Fe_{0.2}Nb_{0.2}O_{5+δ} (PBCFN), including the following specific steps:
(1) according to the stoichiometric ratio, weighing 4.3501 g of praseodymium nitrate, 2.6135 g of barium nitrate, 4.6565 g of cobalt nitrate, 0.808 g of iron nitrate, and 0.606 g of niobium ammonium oxalate, dissolving them in 100-300 mL of deionized water; subsequently, according to the molar ratio of metal ions (including Pr, Ba, Co, Fe and Nb):glycine:citric acid monohydrate of 1:0.75:0.75, adding 6.3042 g of glycine and 2.2521 g of citric acid monohydrate as complexing agent to the above solution, so as to obtain a mixed solution;
(2) heating and stirring the obtained mixed solution at 85° C. until the water evaporated to obtain a gel-like material;
(3) oven-drying the gel-like material in an air blast drying oven at 300° C. for 2 hours to obtain a fluffy porous precursor; and
(4) calcining the precursor in a high-temperature muffle furnace at 1000° C. for 2 hours to obtain the desired cathode material powder PrBaCo_{1.6}Fe_{0.2}Nb_{0.2}O_{5+δ}, which was recorded as PBCFN cathode material powder.

### Example 2

This example provided a solid oxide fuel cell of NiO-YSZ|YSZ|GDC|PBCFN comprising NiO-YSZ as anode (that is, a single cell comprising a blank NiO-YSZ as anode), the preparation of which specifically included the following steps:
(1) preparation of phase conversion anode slurry: mixing 30 g of NiO, 20 g of YSZ, 18 g of 1-methyl-2-vinylpyrrolidone, 3 g of polyethersulfone, and 0.75 g of polyvinylpyrrolidone evenly to obtain the NiO-YSZ phase conversion anode slurry; preparation of phase conversion graphite layer slurry: mixing 10 g of graphite, 15 g of 1-methyl-2-vinylpyrrolidone, 2.5 g of polyethersulfone, and 0.625 g of polyvinylpyrrolidone evenly to obtain the phase conversion graphite layer slurry; placing each of the above slurries in a roller ball mill for ball-milling 70-80 hours;
(2) casting the ball-milled graphite layer slurry and anode slurry onto a glass substrate successively (with a graphite layer thickness controlled to be 0.2-0.3 millimeters and an anode layer thickness controlled to be 0.6-0.7 millimeters), then soaking the obtained graphite/anode layer in deionized water for 10 hours and then taking out for air-drying; after the graphite/anode layer was completely dried, shaping the dried graphite/anode layer into several thin sheets with a diameter of 15 mm by using a molding die with a diameter of 15 mm; placing the shaped thin sheets in a muffle furnace and degreasing at 1000° C. for 2 hours, during the temperature increasing and decreasing process, a slow heating rate of 0.5° C./min was required to completely remove the organic components in the thin sheets and the graphite layer at the bottom, while ensuring that the prepared half cell had a certain degree of mechanical strength; and blowing off the graphite layer adsorbed on the surface of the circular thin sheet to obtain the Ni-YSZ anode;
(3) preparation of NiO-YSZ functional layer solution: mixing 0.5 g of NiO, 0.5 g of YSZ, 0.5 g of dispersant, and 10 g of ethanol evenly and then subjecting to ball-milling in a roller ball mill for 24 hours; preparation of YSZ electrolyte solution: mixing 1 g of YSZ, 0.5 g of dispersant, and 10 g of ethanol evenly and then subjecting to ball-milling in a roller ball mill for 24 hours; infiltrating the NiO-YSZ functional layer solution and the YSZ electrolyte solution onto the NiO-YSZ anode successively, and then calcining in a muffle furnace at 1350° C. for 5 hours to obtain an anode supported half cell;
(4) preparation of GDC barrier layer solution: mixing 1 g of GDC powder (10 mol % Gd₂O₃-doped CeO₂), 0.15 g of ethyl cellulose, 1.85 g of terpineol, and 10 g of acetone evenly and then subjecting to ball-milling in a roller ball mill for 24 hours; subsequently infiltrating the prepared GDC barrier layer solution on the YSZ electrolyte layer and calcining in a muffle furnace at 1300° C. for 2 hours;
(5) weighing 1 g of the cathode material powder PrBaCo_{1.6}Fe_{0.2}Nb_{0.2}O_{5+δ} prepared in Example 1, 0.76 g of terpineol and 0.04 g of ethyl cellulose, and placing the same in a mortar and grinding for 1 hour to obtain the desired cathode slurry (PBCFN);
(6) evenly applying the prepared cathode slurry on the prepared phase conversion anode supported half cell (i.e., the product obtained in step (4)) by a screen printing method; drying the obtained phase conversion anode supported half cell in an oven, and then calcining in a high-temperature muffle furnace at 1000° C. for 2 hours, so as to prepare the desired solid oxide fuel cell.

### Example 3

This example provided a cell (Ru/Ce_{0.95}Ru_{0.05-x}O_{2-δ}/NiO-YSZ|YSZ|GDC|PBCFN) comprising Ru/Ce_{0.95}Ru_{0.05-x}O_{2-δ} nanoparticles coated phase conversion Ni-YSZ anode, the preparation of which included the following specific steps:
(1) dissolving 0.412509 g Ce(NO₃)₃·6H₂O powder sample and 0.3369 mL of Ru(NO)(NO₃)ₓ(OH)_{y}, x+y=3 (purchased from Macklin, 1.5% w/v) in 10 mL of deionized water, and standing for 24 hours until completely dissolved to obtain a Ce_{0.95}Ru_{0.05}O_{2-δ} catalyst solution with a total concentration of Ce and Ru of 0.1 mol/L;
(2) infiltrating 150 μL of 0.1 mol/L Ce_{0.95}Ru_{0.05}O_{2-δ} catalyst solution into the uncovered side of the NiO-YSZ anode (i.e., the anode of the NiO-YSZ|YSZ|GDC|PBCFN cell prepared in Example 2), and under capillary force, the solution was sucked into the NiO-YSZ pore to obtain an infiltrated sample; subsequently, oven-drying the sample coated with Ce_{0.95}Ru_{0.05}O_{2-δ} catalyst in an oven in an air atmosphere at 70° C. for 30 minutes; taking the sample out and repeating the infiltration and oven-drying processes to obtain the NiO-YSZ anode with a Ce_{0.95}Ru_{0.05}O_{2-δ} catalyst loading of 2.51 mg cm⁻²; calcining the obtained anode at 800° C. in an ambient air atmosphere for 1 hour, and then introducing hydrogen at a flow rate of 30 mL/min for reduction at 800° C. for 1 hour.

### Characterization Results

### 1. Transmission Electron Microscopy Characterization

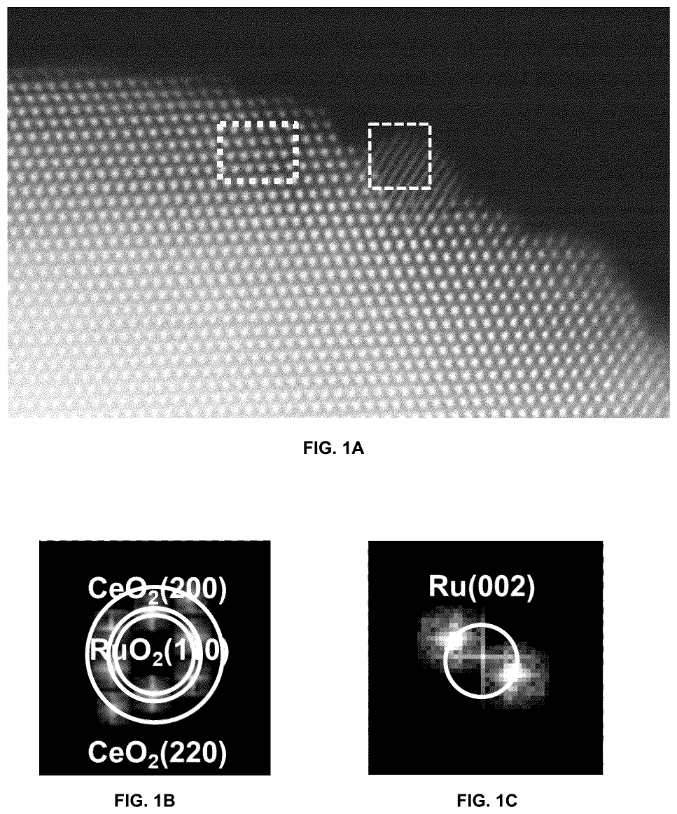

FIG. 1A, FIG. 1B and FIG. 1C show the transmission electron microscopy image of Ce_{0.95}Ru_{0.05}O_{2-δ} catalyst powder after 2 hours of hydrogen reduction at 800° C. according to the present disclosure. It can be observed that after the reduction process, Ru nanoparticles forms on the surface of the CR₅₋ₓO oxide skeleton. The Fast Fourier Transform (FFT) pattern in the white box shows a lattice spacing of 0.214 nm, which corresponds to the (002) crystal plane of Ru. In the black box, RuO₂ (110) crystal plane, CeO₂ (200) crystal plane, and CeO₂ (200) crystal plane can be observed.

### 2. X-Ray Diffraction Characterization

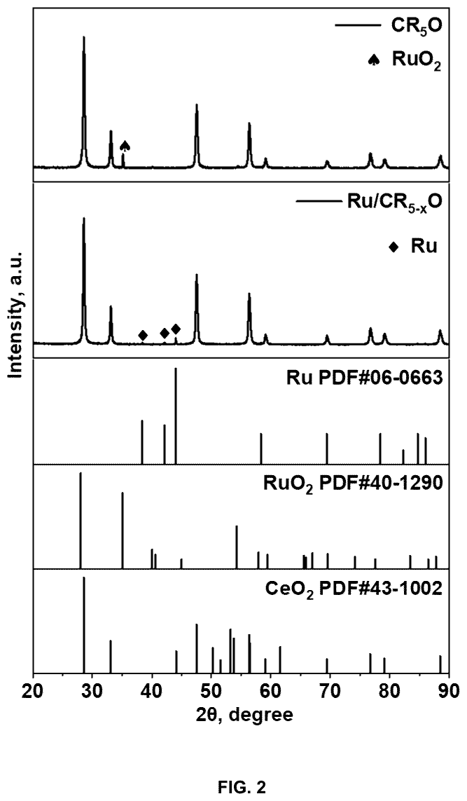

FIG. 2 shows XRD patterns of the Ce_{0.95}Ru_{0.05}O_{2-δ} powder before reduction and after reduction in a 4% H₂—Ar mixed gas at 800° C. for 2 hours. Before reduction, the diffraction peaks (PDF #40-1290) corresponding to RuO₂ can be clearly observed. After reduction, the diffraction peaks related to RuO₂ disappear, while the peaks corresponding to metal Ru appear. No obvious peak of RuO is observed in CR₅O powder before reduction, indicating that Ru mainly exists in the form of RuO₂ or Ru (IV).

### 3. X-Ray Photoelectron Spectroscopy Characterization

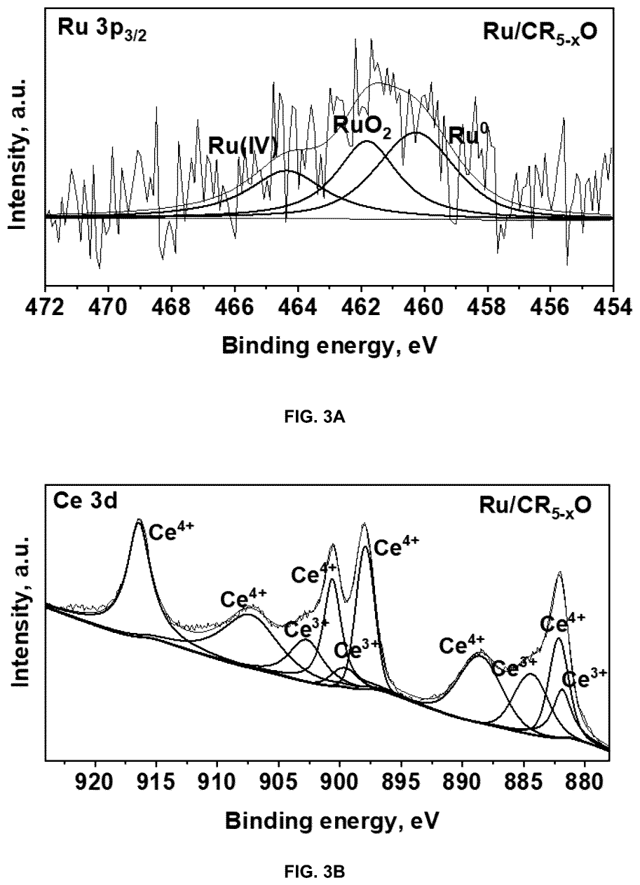

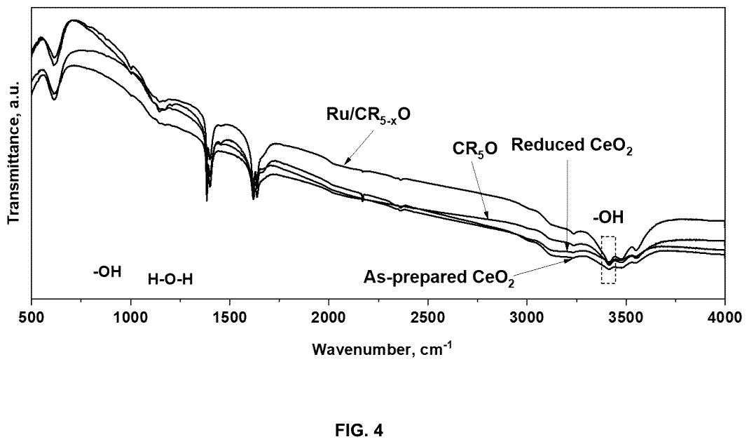

FIG. 3a shows the XPS pattern and corresponding fitted lines of Ru 3p_{3/2} orbitals of Ru/Ce_{0.95}Ru_{0.05-x}O_{2-δ} powder, indicating that the three chemical states of Ru in the sample are Ru⁰, RuO₂ and Ru(IV) with percentages of 40.69%, 32.80%, and 26.51%, respectively. FIG. 3b shows the XPS pattern of Ce 3d orbitals of Ru/Ce_{0.95}Ru_{0.05-x}O_{2-δ} powder, indicating that the proportions of tetravalent cerium ions and trivalent cerium ions are 76.52% and 23.48%, respectively.

### 4. Fourier Transform Infrared Spectroscopy Characterization

The as-prepared CeO₂ which was treated by the wet air at 750° C. for 2 hours, the reduced CeO₂ which was treated by the wet 4% H₂—Ar mixed gas at 750° C. for 2 hours, Ce_{0.95}Ru_{0.05}O_{2-δ} (CR₅O) and Ru/Ce_{0.95}Ru_{0.05-x}O_{2-δ} (Ru/CR₅₋ₓO) powder samples were subjected to Fourier transform infrared spectroscopy (FTIR) characterization, wherein the wet air was obtained by passing the air through a bubbling bottle filled with water, and the wet 4% H₂—Ar mixed gas was obtained by passing the 4% H₂—Ar mixed gas through a bubbling bottle filled with water. Ru/CR₅₋ₓO exhibits significant hydroxyl peaks (between 3300 cm⁻¹ and 3700 cm⁻¹), indicating that Ru/CR₅₋ₓO has excellent hydration ability. The water (or hydroxyl species) on the Ru/CR₅₋ₓO catalyst may participate in the internal reforming process of hydrocarbons, thereby achieving excellent hydrocarbon durability and coking resistance.

### 5. Scanning Electron Microscopy Characterization

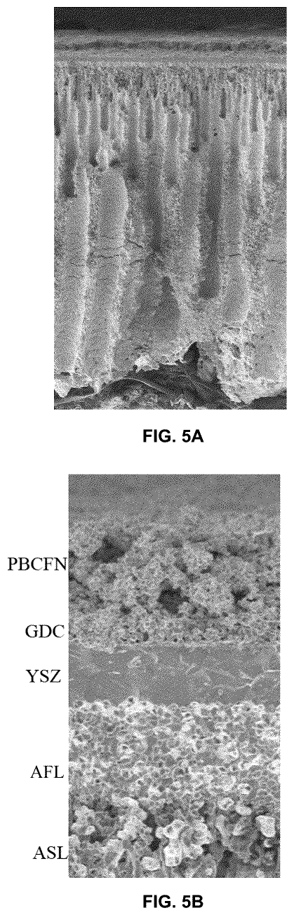

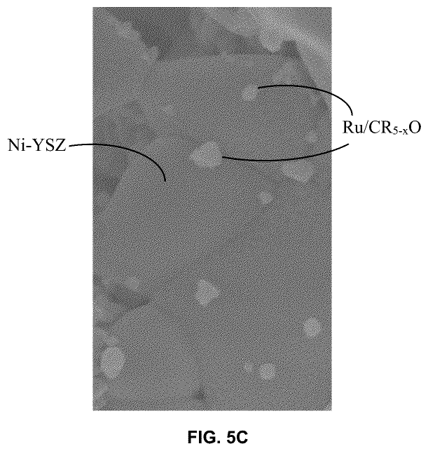

FIG. 5a shows the sectional view of solid oxide fuel cell of Ru/Ce_{0.95}Ru_{0.05-x}O_{2-δ}/Ni-YSZ|YSZ|GDC|PBCFN prepared in Example 3 of the present disclosure after being tested under methanol conditions. FIG. 5b shows that the cell has distinct anode supported layer (Ni-YSZ), anode functional layer (Ni-YSZ), electrolyte layer (YSZ), barrier layer (GDC) and cathode layer (PBCFN), wherein the anode support layer is represented by ASL, and the anode functional layer is represented by AFL. It can see that Ru/Ce_{0.95}Ru_{0.05-x}O_{2-δ} catalyst is attached to the inner tube wall of ASL in the form of nanoparticles. After testing under methanol conditions, the cell structure remained in good condition, with no collapse and no obvious carbon deposition was observed. FIG. 5c shows the enlarged SEM image of Ru/Ce_{0.95}Ru_{0.05-x}O_{2-δ}-coated (2.51 mg/cm² Ce_{0.95}Ru_{0.05}O_{2-δ}) phase conversion anode (prepared in Example 3) according to the present disclosure after tested under methanol conditions, where Ru/Ce_{0.95}Ru_{0.05-x}O_{2-δ} catalyst is attached to the inner tube wall of ASL in the form of nanoparticles. It can be seen from FIG. 5c that a layer of Ru/Ce_{0.95}Ru_{0.05-x}O_{2-δ} nanoparticles is coated on the surface of Ni-YSZ.

### 6. Output Power Characterization

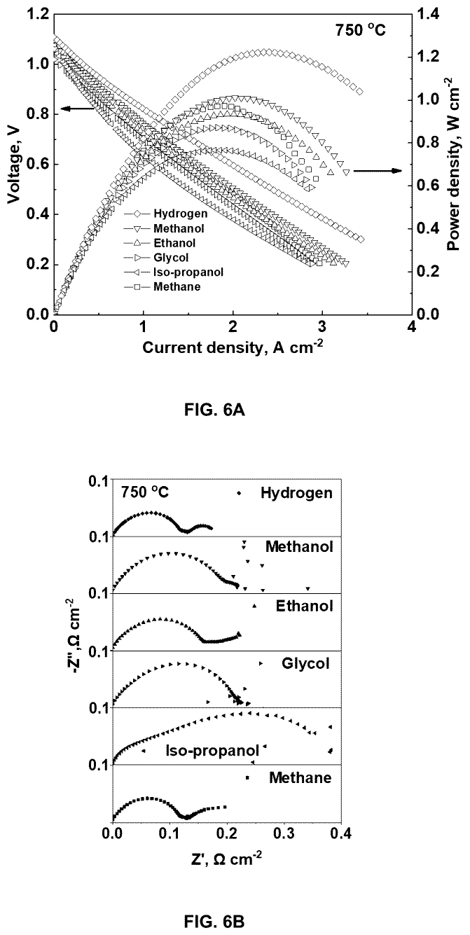

FIG. 6a shows the I-V-P curve of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 750° C. using hydrogen, methanol, ethanol, ethylene glycol, isopropanol, and methane as fuel gas and ambient air as oxidant. At 750° C., the cell achieved an ultra-high power density of 1.010 W/cm² under methanol conditions. When using other liquid fuels as fuel gas, such as ethanol, ethylene glycol, and isopropanol, the single cell also achieved excellent performance of 0.934 W/cm², 0.872 W/cm², 0.768 W/cm², and 0.973 W/cm² at 750° C.

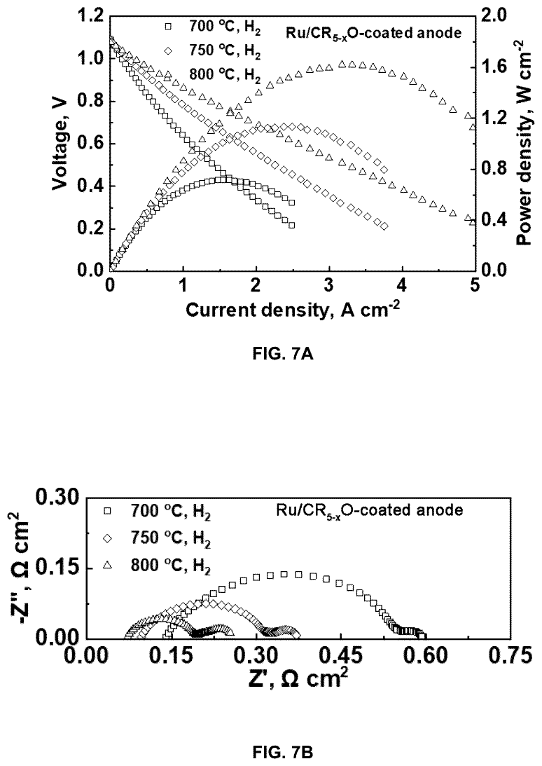

FIG. 7a shows the I-V-P curve of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 700-800° C. using hydrogen as fuel gas and ambient air as oxidant.

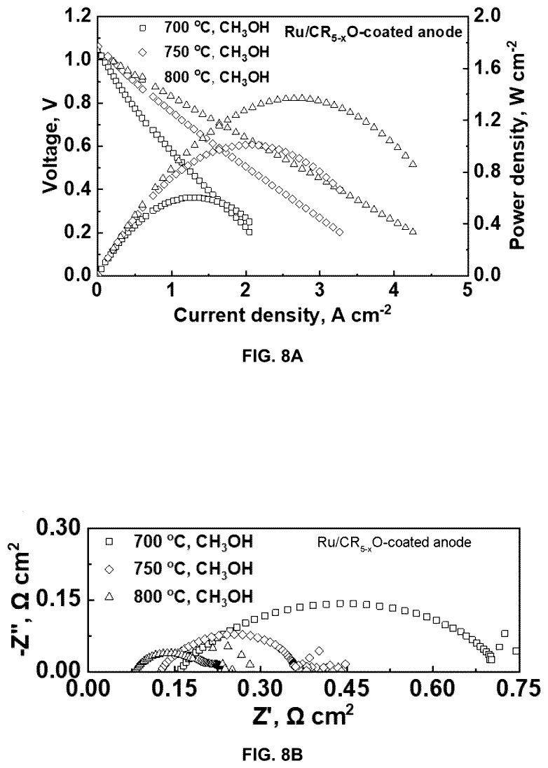

FIG. 8a shows the I-V-P curve of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 700-800° C. using methanol as fuel gas and ambient air as oxidant. When methanol was used as fuel, the single cell comprising such anode structure achieved ultra-high power densities of 0.604 W/cm², 1.010 W/cm², and 1.370 W/cm² at 700° C., 750° C., and 800° C., respectively.

### 7. Impedance Characterization

FIG. 6b shows the polarization impedance diagram of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 750° C. using hydrogen, methanol, ethanol, ethylene glycol, isopropanol, and methane as fuel gas and ambient air as oxidant. FIG. 7b shows the area specific impedance diagram of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 700-800° C. using hydrogen as fuel gas and ambient air as oxidant. FIG. 8b shows a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 700-800° C. using methanol as fuel gas and ambient air as oxidant. It can be seen that cells coated with a catalyst exhibit lower area specific resistance at different temperatures and fuel atmospheres.

### 8. Characterization of Single Cell Stability

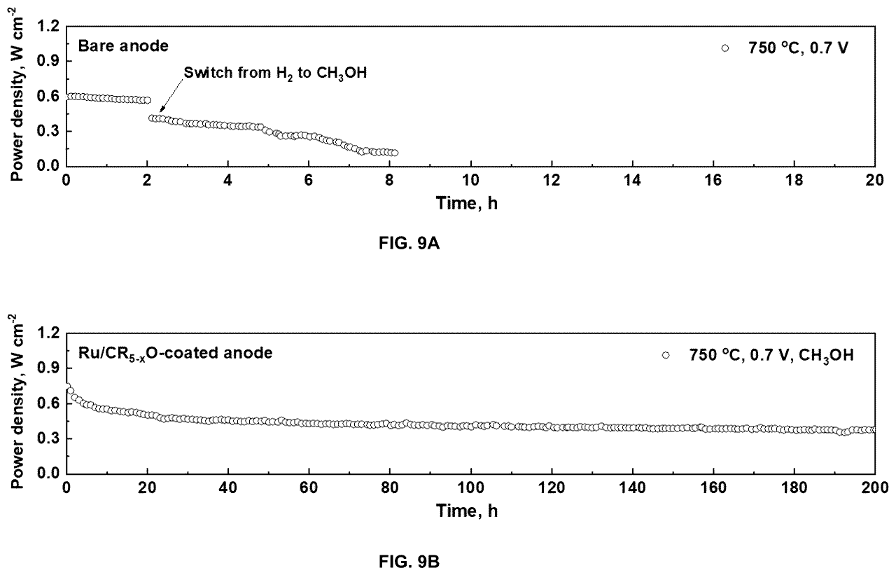

FIG. 9a shows the stability test results of a single cell comprising blank Ni-YSZ as anode (i.e., single cell Ni-YSZ|YSZ|GDC|PBCFN) according to the present disclosure measured at 750° C. using hydrogen/methanol as fuel gas and ambient air as oxidant; and FIG. 9b shows the stability test results of a single cell comprising Ru/Ce_{0.95}Ru_{0.05-x}O_{2-δ}-coated Ni-YSZ as anode (i.e., single cell Ru/Ce_{0.95}Ru_{0.05-x}O_{2-δ}/Ni-YSZ|YSZ|GDC|PBCFN prepared in Example 3) according to the present disclosure measured at 750° C. using hydrogen/methanol as fuel gas and ambient air as oxidant. When an external voltage of 0.7 V was applied, the cell comprising the anode coated with catalyst achieved a higher output voltage under methanol conditions and remained stable for about 200 hours, indicating good direct methanol durability of the cell.

### 9. Raman Spectrum Characterization

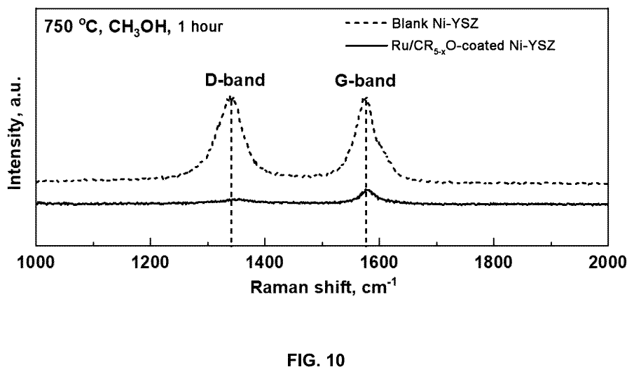

FIG. 10 shows the typical Raman spectrum of the blank Ni-YSZ sample and Ru/Ce_{0.95}Ru_{0.05-x}O_{2-δ}-coated Ni-YSZ sample after being exposed to CH₃OH for 1 hour at 750° C. Strong carbon peaks in the D band (about 1357 cm⁻¹) and G band (about 1585 cm⁻¹) were observed in the Raman spectra of the blank Ni-YSZ sample, indicating a large amount of carbon deposition. On the contrary, the dense Ni-YSZ thin sheet coated with catalysts did not exhibit obvious D-band and G-band peaks.

The above examples are preferred embodiments of the present disclosure, which are not limited by the above examples. Any other changes, modifications, substitutions, combinations, and simplifications made without departing from the spirit and principles of the present disclosure should be equivalent permutations and all of which are included within the protection scope of the present disclosure.

1. An anti-carbon-deposition liquid fuel solid oxide fuel cell anode with self-hydration ability, comprising:
a NiO-YSZ anode; and
an oxide skeleton Ru/Ce_{0.95}Ru_{0.05-x}O_{2-δ} loaded on the NiO-YSZ anode,
wherein the oxide skeleton Ru/Ce_{0.95}Ru_{0.05-x}O_{2-δ} is covered with Ru nanoparticles, and δ indicates a content of oxygen vacancy.

2. The anti-carbon-deposition liquid fuel solid oxide fuel cell anode with self-hydration ability according to claim 1, wherein the NiO-YSZ anode has a finger-like through-hole structure, the NiO-YSZ anode mainly consists of NiO and YSZ, and YSZ is 8 mol % Y₂O₃-stabilized ZrO₂.

3. A preparation method of the anti-carbon-deposition liquid fuel solid oxide fuel cell anode with self-hydration ability according to claim 1, comprising the following steps:
(1) preparing a catalyst solution containing cerium and ruthenium; and
(2) infiltrating the catalyst solution on a surface of a NiO-YSZ anode, infiltrating and then oven-drying, calcining, and reducing to obtain an anti-carbon-deposition liquid fuel solid oxide fuel cell anode with self-hydration ability.

4. The preparation method of the anti-carbon-deposition liquid fuel solid oxide fuel cell anode with self-hydration ability according to claim 3,
wherein, the catalyst solution containing cerium and ruthenium in step (1) is an aqueous solution comprising cerium nitrate and nitrosyl ruthenium nitrate;
a molar ratio of cerium to ruthenium in step (1) is 19:1; and
a total concentration of cerium and ruthenium in the catalyst solution in step (1) is 0.05-0.2 mol/L.

5. The preparation method of the anti-carbon-deposition liquid fuel solid oxide fuel cell anode with self-hydration ability according to claim 3, wherein the calcination in step (2) is conducted in an atmosphere of ambient air at a temperature of 700-800° C. for 1-2 hours.

6. The preparation method of the anti-carbon-deposition liquid fuel solid oxide fuel cell anode with self-hydration ability according to claim 3, wherein the NiO-YSZ anode in step (2) is prepared by a method comprising the following steps:
S1: ball-milling NiO, YSZ, a water-soluble polymer compound, a thermoplastic polymer material, and an organic solvent to obtain a NiO-YSZ anode slurry; and ball-milling graphite, an organic solvent, a thermoplastic polymer material, and a water-soluble polymer compound to obtain a graphite slurry;
S2: casting the graphite slurry onto a substrate to obtain a graphite layer; casting the NiO-YSZ anode slurry onto the graphite layer to obtain a graphite/anode layer; and soaking the graphite/anode layer in water to complete the phase conversion process; and
S3: taking out the graphite/anode layer that has completed the phase conversion process, drying in air, calcining during which the graphite layer is burned off at high temperature and removed from a surface, to obtain a Ni-YSZ anode with a finger-like through-hole structure.

7. The preparation method of the anti-carbon-deposition liquid fuel solid oxide fuel cell anode with self-hydration ability according to claim 6, wherein in the anode slurry in step S1, a mass ratio of the water-soluble polymer compound, the thermoplastic polymer material, and the organic solvent is (0.1-0.3):1:(5-7); a mass ratio of NiO to the water-soluble polymer compound is (30-50):(0.5-1.5); and a mass ratio of NiO to YSZ is (5.5-6.5):(3.5-4.5).

8. The preparation method of the anti-carbon-deposition liquid fuel solid oxide fuel cell anode with self-hydration ability according to claim 6, wherein in the graphite slurry in step S1, a mass ratio of graphite, the water-soluble polymer compound, the thermoplastic polymer material, and the organic solvent is (10-30):(1-1.5):(4-6):(20-40).

9. The preparation method of the anti-carbon-deposition liquid fuel solid oxide fuel cell anode with self-hydration ability according to claim 6, wherein a thickness of the graphite/anode layer in step S2 is 0.6-0.7 millimeters.

10. An anti-carbon-deposition liquid fuel solid oxide fuel cell with self-hydration ability, comprising the anti-carbon-deposition liquid fuel solid oxide fuel cell anode with self-hydration ability of claim 1, a functional layer, an electrolyte layer, a barrier layer and a cathode which are stacked successively.

11. The anti-carbon-deposition liquid fuel solid oxide fuel cell with self-hydration ability according to claim 10,
wherein, the functional layer is composed of NiO and YSZ, with a mass ratio of NiO to YSZ of (0.8-1):(0.8-1);
the electrolyte layer is YSZ;
the barrier layer is a GDC barrier layer, wherein GDC is 10 mol % Gd₂O₃-doped CeO₂; and
the cathode is a double perovskite oxide PrBaCo_{1.6}Fe_{0.2}Nb_{0.2}O_{5+δ}, wherein δ indicates a content of oxygen vacancy.

12. The anti-carbon-deposition liquid fuel solid oxide fuel cell with self-hydration ability according to claim 10, wherein the solid oxide fuel cell is an oxygen ion conductor solid oxide fuel cell which uses liquid hydrocarbons as fuels.

13. A preparation method of the anti-carbon-deposition liquid fuel solid oxide fuel cell with self-hydration ability according to claim 10, comprising the following steps:
1) preparing a NiO-YSZ anode with a finger-like through-hole structure;
2) infiltrating a NiO-YSZ functional layer slurry and a YSZ electrolyte layer slurry onto the NiO-YSZ anode with the finger-like through-hole structure successively, and then performing co-sintering;
3) coating a GDC barrier layer slurry onto an electrolyte layer, sintering to obtain a GDC barrier layer to block a reaction between the YSZ electrolyte and a PBCFN cathode;
4) preparing a cathode on the barrier layer, to obtain a solid oxide fuel cell, wherein a double perovskite oxide PrBaCo_{1.6}Fe_{0.2}Nb_{0.2}O_{5+δ} is used as a cathode of the solid oxide fuel cell, and δ indicates a content of oxygen vacancy; and
5) infiltrating a catalyst solution onto an uncovered side of the NiO-YSZ anode with the finger-like through-hole structure of the solid oxide fuel cell, then oven-drying, calcining, and reducing to obtain an anti-carbon-deposition liquid fuel solid oxide fuel cell with self-hydration ability.

14. The preparation method of the anti-carbon-deposition liquid fuel solid oxide fuel cell with self-hydration ability according to claim 13, wherein the NiO-YSZ functional layer slurry in step 2) is obtained by ball-milling NiO, YSZ, a dispersant polyvinyl butyral (PVB), and ethanol; and a mass ratio of NiO, YSZ, the dispersant, and ethanol is 0.5:0.5:(0.4-0.6):(5-15).

15. The preparation method of the anti-carbon-deposition liquid fuel solid oxide fuel cell with self-hydration ability according to claim 13, wherein the YSZ electrolyte layer slurry in step 2) is obtained by ball-milling YSZ, a dispersant polyvinyl butyral (PVB), and ethanol; and a mass ratio of YSZ, the dispersant, and ethanol is 1:(0.1-1):(8-15).

16. The preparation method of the anti-carbon-deposition liquid fuel solid oxide fuel cell with self-hydration ability according to claim 13, wherein the GDC barrier layer slurry in step 3) is obtained by ball-milling GDC, ethyl cellulose, terpineol, and acetone; and a mass ratio of GDC, ethyl cellulose, terpineol, and acetone is (0.5-1):(0.1-0.2):(1.8-2.0):10.

17. The preparation method of the anti-carbon-deposition liquid fuel solid oxide fuel cell with self-hydration ability according to claim 13, wherein the cathode in step 4) is obtained by a method comprising the following steps:
P1: dissolving and evenly mixing reagents containing Pr, Ba, Co, Fe, and Nb in water; adding glycine and citric acid, and volatilizing water under heating and stirring to obtain a gel-like material; oven-drying the gel-like material to obtain a PBCFN cathode material precursor, and then calcining the precursor to obtain a PBCFN cathode material powder; and
P2: grinding the PBCFN cathode material powder, ethyl cellulose, and terpineol into slurry, then screen-printing on a surface of GDC, and calcining at high temperature to obtain the cathode.

18. The preparation method of the anti-carbon-deposition liquid fuel solid oxide fuel cell with self-hydration ability according to claim 17, wherein a molar ratio of Pr, Ba, Co, Fe, and Nb in step P1 is 1:1:1.6:0.2:0.2.

19. The preparation method of the anti-carbon-deposition liquid fuel solid oxide fuel cell with self-hydration ability according to claim 17, wherein a molar ratio of metal ions (including Pr, Ba, Co, Fe, and Nb):glycine:citric acid in step P1 is 1:(0.5-1):(0.5-1).

20. The preparation method of the anti-carbon-deposition liquid fuel solid oxide fuel cell with self-hydration ability according to claim 17, wherein a mass ratio of the cathode material powder:ethyl cellulose:terpineol in step P2 is 1:(0.02-0.06):(0.74-0.78).
